(19) United States
(12) Patent Application Publication
(10) Pub. No.: US 2010/0198667 A1
(43) Pub. Date: Aug. 5, 2010

(54) ALTERNATIVE OUTDOOR ADVERTISING METHOD

(76) Inventors: James H. Johnson, JR., Lexington, KY (US); Warren D. Schickli, Lexington, KY (US)

Correspondence Address: KING & SCHICKLI, PLLC, 247 NORTH BROADWAY, LEXINGTON, KY, 40507, US

(21) Appl. No.: 11/996,760

(22) PCT Filed: Jul. 24, 2006
(86) PCT No.: PCT/US06/28570

§ 371 Date: Jan. 25, 2008

Related U.S. Application Data
(60) Provisional application No. 60/763,709, filed on Jan. 31, 2006.
(60) Provisional application No. 60/702,476, filed on Jul. 26, 2005.

(51) Int. Cl. G06Q 30/00; B60P 1/00; G06Q 10/00

(52) U.S. Cl. 705/14.4; 414/812; 705/28

(57) ABSTRACT

A storage method includes the steps of delivering a storage container to a customer, leaving the storage container at a site selected by the customer and marketing advertising space on the storage container (see FIG. 1).

This application claims the benefit of U.S. Provisional Patent Applications Ser. Nos. 60/702,476 filed on 26 Jul. 2005 and 60/763,709 filed on 31 Jan. 2006.

### TECHNICAL FIELD

The present invention relates generally to the storage and outdoor advertising fields.

### BACKGROUND OF THE INVENTION

As a successful business grows, it generally has a need for more space in order to meet its need to provide customers with goods and/or services. Thus, many businesses today presently need additional storage space and/or inventory control. Generally they meet this need by either (a) changing locations, (b) making a substantial capital investment in a building expansion or ©) renting mini-warehousing space at another, remote site.

For many businesses, relocating is not an option as the location itself is a key to the business. For many others insufficient capital is available for building expansion. Further, the need for additional storage is often a short term or seasonal one not fully justifying a substantial capital expense. Further, while mini-warehousing may be a viable option for some businesses, it is inconvenient since a trip is required to the remote site in order to retrieve needed items or supplies. Since a mini-warehouse location is often a significant distance from the place of business, substantial labor time is lost when an employee is required to retrieve items. Further, with the high cost of gasoline and the potential liability risk run when an employee is driving his or her vehicle in a business capacity, substantial expense is also incurred.

The present invention provides a fourth and for many businesses a better, alternative solution to the space problem.

### SUMMARY OF THE INVENTION

In accordance with the purposes of the present invention as described herein, a storage method is provided. The storage method comprises the steps of delivering a storage container to a customer, leaving the storage container at a site selected by the customer and marketing advertising space on the storage container. More specifically, the delivering steps include hauling a prefabricated storage container with a vehicle. The leaving step includes using a carrier frame to remove the storage container from the vehicle and place the storage container at the site.

In addition the method may include the step of retrieving the storage container from the site at a designated time. That retrieving includes using a carrier frame to lift the storage container onto a vehicle. During lifting the storage container is maintained substantially level so as to prevent tipping of stored articles and protect the contents of the storage container from damage.

In accordance with yet another aspect of the present invention the method may include the storing of a storage container in a warehouse and the providing of the customer with access to the storage container stored in that warehouse.

In the following description there is shown and described a preferred embodiment of the invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention, and together with the description serves to explain certain principles of the invention. In the drawing:

FIG. 1 is a perspective view of a storage container provided to a customer through the method of the present invention; and

FIG. 2 is a schematical end elevational view of a storage container through the open end doors.

Reference will now be made in detail to the present preferred embodiment of the invention, an example of which is illustrated in the accompanying drawing.

### DETAILED DESCRIPTION OF THE INVENTION

The present method may be generally and broadly described as including the steps of delivering a storage container to a customer, leaving the storage container at a site selected by the customer and marketing advertising space on the storage container. That delivering step includes hauling a prefabricated storage container with a vehicle such as a truck or trailer pulled by a truck or other motor vehicle. In addition the leaving step includes using a carrier frame to remove the storage container from the vehicle and place the storage container at the site. A carrier frame of this type is well known in the art and described in detail in, for example, U.S. Pat. No. 6,155,770 the full disclosure of which is incorporated herein by reference.

In addition the method may include the step of retrieving the storage container from the site at a designated time. This retrieval may be at customer request such as after completing a special sale or promotion. The retrieval may be in accordance with local regulation allowing the container to remain at the site for only a limited period of time. This retrieving includes using a carrier frame such as of the type disclosed in U.S. Pat. No. 6,155,770 or some other device to lift the storage container 10 onto a vehicle such as a truck bed or trailer. During lifting the storage frame functions to maintain the storage container substantially level so as to prevent tipping of stored articles and protect the contents placed in the storage container by the customer. In addition the method may include storing the storage container in a warehouse and providing the customer access to the storage container stored in the warehouse. That warehouse may be subject to climate control so as to provide and maintain a temperature level, a humidity level or the like in a desired range. That access may be on a 24-hour basis for the convenience of the customer.

As noted above the storage method includes the step of marketing advertising space on the storage container. More specifically describing the invention the method may include providing a banner on the storage container. In one possible embodiment the method includes the illuminating of that banner. Illumination may be performed in any manner including up lighting, down lighting or even back lighting the banner. In one possible embodiment the method includes using an electroluminescent material for the banner. Such a material is self-illuminating in the absence of any other light source. Further, the method may include printing the banner with digital graphics. Illuminated digital graphics provide a particularly effective advertising medium. Still further, the method may include providing an electronic display device such as a plasma monitor, liquid crystal display, a rotary sign assembly such as disclosed in U.S. Pat. No. 4,021,946, an electronic message board or the like on the storage container 10.

In accordance with yet additional aspects of the present invention, the method includes the rotating of the advertising provided on the storage container. In addition the method may include back lighting or down lighting the advertising so as to provide better visibility at night. In addition the method may include providing short range radio transmission advertising such as low wattage transmission on 89.1 FM. The transmitter may be located anywhere within a given radius (e.g. within 200 yards) of the storage container 10 or even on the storage container.

Still further, the method may include site preparation for a semipermanent installation of the storage container 10. Such site preparation may include construction of a foundation for the container 10 from poured concrete or other material, anchoring of the storage container 10 to the ground and/or the tapping into electrical, water and/or natural gas utility lines.

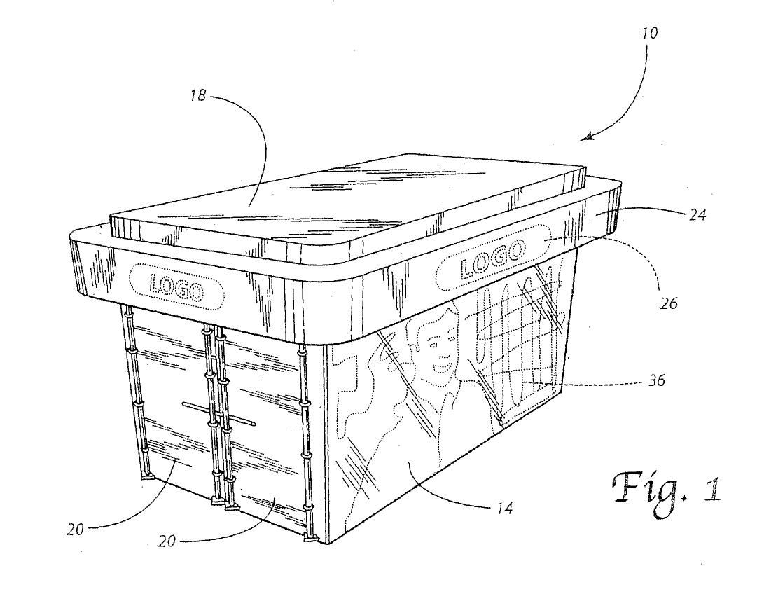

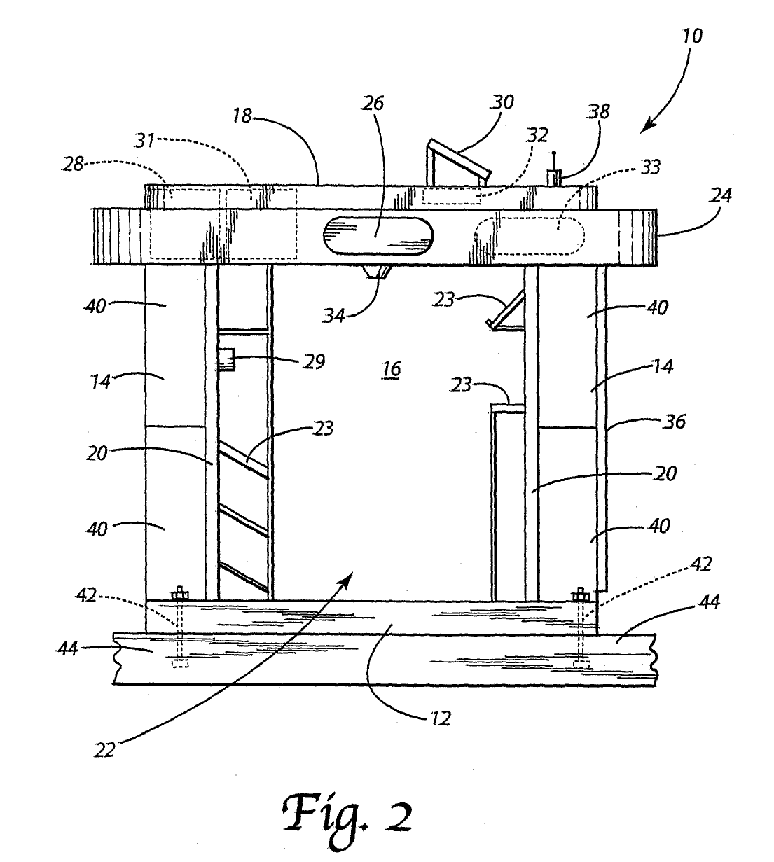

One possible construction of an integrated advertising and storage container or “box billboard” 10 is illustrated in FIGS. 1-2. More specifically, the storage container 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior storage space 22. That storage space 22 may be customized to meet the customer's needs including particular rack, shelving, partitioning layouts (note shelves 23) as required or desired by the customer for purposes of inventory storage and control. The interior customization may be tailored to integrate with inventory control technology such as bar coding.

Similarly, the exterior of the storage container 10 may be customized to match the trade dress and/or architectural features of the customer's main building near which the storage container 10 may be placed into service. Thus, for example, the storage container 10 may include a decorative roof cap 24 sized and shaped to customer specifications. The roof cap 24 may include customer advertising, trade dress or logo 26 if desired and/or as allowed.

The storage container 10 may also be equipped with various electrical and/or mechanical systems. For example, a climate control unit 28 such as an air conditioner, refrigerator, freezer, humidifier or dehumidifier may be provided on the storage container 10 in order to provide climate control of the storage space 22 within the storage container. Accordingly, products such as perishable food, dairy products, soft drinks and beer may be maintained at the desired temperatures even in hot and humid environments.

In addition, the storage container 10 may be equipped with a solar panel 30 and cooperating battery 32 to store energy for powering an internal lighting system 34 for illuminating the storage space 22 or illuminating advertising 36 on the side wall 14, end wall 16 or other exterior component of the storage container 10. That advertising 36 may comprise a stretched banner material and it may be front lit or back lit as desired. Alternatively, the banner may be made from a luminescent film or foil such as disclosed in, for example, U.S. Pat. Nos. 5,676,451 and 6,637,906, so as to be self-illuminating. The banner may be printed with a high quality digital graphic image. In one possible embodiment the various electrical and mechanical components of the container 10 may derive their power from tapping into the lines of the local electrical utility company and/or from connection with some other form of electric generator or fuel cell.

Still further, the storage container 10 may incorporate a radio transmitter 38 for the transmission of short range advertisements respecting products displayed in the advertising 36 appearing on the exterior surface of the storage container 10. A particularly effective advertising combination is the use of a backlit digital graphic advertising banner 36 in conjunction with local transmission radio advertising providing details of the particular product. This is particularly effective when advertising a product that is sold at the customer's place of business.

For certain applications, the structure 10 may be constructed, for example, from modular building materials such as prefabricated panels 40 of the type shown and described in, for example, U.S. Pat. No. 6,279,287 to Meadows, U.S. Pat. No. 5,373,678 to Hesser and U.S. Pat. No. 6,119,427 to Wyman et al. Such modular panels 40 typically incorporate a core of thermal insulating material sandwiched between metal or plastic sheathing. Such a construction provides a significant R-factor for both efficient and effective control of the temperature and humidity of the environment in the internal space 22 and excellent inclement weather durability for a long, low-maintenance service life. Structures 10 constructed from such modular building panels 40 are also characterized by high strength and will resist high winds and maintain a weather-tight enclosure to protect products held in the space 22 from inclement weather. In fact, such structures may be easily anchored to the ground such as by means of cooperating nut and bolt anchors 42 where the bolt is received and held in an underlying poured concrete pad 44. The modular panels 40 also allow the structure 10 to be quickly and easily erected and subsequently removed in a minimal amount of time while producing a minimum of mess.

In accordance with yet another aspect of the present method, the storage container 10 is leased to the customer for a set term. The customer pays a first lease rate when the storage container 10 is stored in the warehouse. The customer pays a second, reduced rate when the storage container 10 is sited at the customer's place of business. In certain situations, the lease payments may be partially or fully waived when the storage container 10 is at the customer's site and advertising revenue may be generated by the unit.

In summary, numerous benefits result from employing the concepts of the present invention. The customer may store inventory or other material where they are protected from inclement weather. Advantageously, the storage space is also provided at a site selected by the customer. Such a site is typically conveniently located next to the customer's main building of business. Thus, for example, a convenience store operator may store an extra inventory of cold soft drinks and beer immediately adjacent the customer's retail location. The substantially cost-free, onsite storage provided by the present method is an attractive alternative when compared to leased, remotely located mini-warehousing.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the advertising 36 may comprise the direct application of graphics to the panels 40 of the structure 10 and down lighting from a light source 42 in the roof cap 24 to illuminate those graphics. The structure 10 could also include a display system such as a plasma monitor, liquid crystal display, a rotary sign assembly, an electronic message board or the like to display advertising 36.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A storage method, comprising:
delivering a storage container to a customer;
leaving said storage container at a site selected by said customer; and
marketing advertising space on said storage container.

2. The storage method of claim 1, wherein said delivering includes hauling a prefabricated storage container with a vehicle.

3. The storage method of claim 2, wherein said leaving includes using a carrier frame to remove said storage container from said vehicle and place said storage container at said site.

4. The storage method of claim 3, further including retrieving said storage container from said site at a designated time.

5. The storage method of claim 4, wherein said retrieving includes using a carrier frame to lift said storage container onto a vehicle.

6. The storage method of claim 5, including maintaining said storage container substantially level during lifting.

7. The storage method of claim 6, including storing said storage container in a warehouse.

8. The storage method of claim 7, including providing customer access to said storage container stored in said warehouse.

9. The storage method of claim 1, wherein said leaving includes using a carrier frame to remove said storage container from said vehicle and place said storage container at said site.

10. The storage method of claim 9, further including retrieving said storage container from said site at customer request.

11. The storage method of claim 10, wherein said retrieving includes using a carrier frame to lift said storage container onto a vehicle.

12. The storage method of claim 11, including maintaining said storage container substantially level during lifting.

13. The storage method of claim 12, including storing said storage container in a warehouse.

14. The storage method of claim 13, including providing customer access to said storage container stored in said warehouse.

15. The method of claim 1, further including placing said storage container adjacent said customer's place of business and allowing said customer use of internal storage space in said storage container.

16. The method of claim 15, further including customizing said internal storage space to meet the needs of said customer.

17. The method of claim 1, further including providing climate control for an internal storage space of said storage container.

18. The method of claim 1, including rotating advertising provided on said storage container.

19. The method of claim 1, including illuminating advertising on said storage container.

20. The method of claim 1, including providing short range radio advertising in a limited area around said storage container.
